(19) United States
(12) Patent Application Publication
(10) Pub. No.: US 2005/0184953 A1
(43) Pub. Date: Aug. 25, 2005

(54) Thumb-operable man-machine interfaces (MMI) for portable electronic devices, portable electronic devices including the same and methods of operating the same

(76) Inventors: William O. Camp JR., Chapel Hill, NC (US); Daniel P. Homiller, Cary, NC (US)

Correspondence Address: Elizabeth A. Stanek;Myers Bigel Sibley & Sajovec, Post Office Box 37428, Raleigh, NC, 27627, US

(21) Appl. No.: 10/783,601

(22) Filed: Feb. 20, 2004

(51) Int. Cl. H04N 5/225

(52) U.S. Cl. 345/156

(57) ABSTRACT

Portable electronic devices are provided including a housing and a display integrated with the housing. A thumb-operable input device is positioned on a side of the housing. An indicator is provided on the display and is operatively associated with the thumb-operable input device. The indicator is positioned on the display to highlight and/or select menu items on the display responsive to input received at the thumb-operable input device. Related man-machine interfaces (MMIs) are also provided.

### BACKGROUND OF THE INVENTION

The present invention relates to portable electronic devices and, more particularly, to man-machine interfaces (MMIs) used to access functionalities of portable electronic devices.

Manufacturers and designers of portable electronic devices, such as mobile telephones, frequently seek to reduce the overall dimensions of such devices while maintaining attractive style characteristics for the devices. One consequence of the reduced size for such devices is that less space may be available for the required components that provide the necessary functionality of the phone as well as components that provide additional functionality. As the space available for the hardware components decreases in the portable electronic devices, it may become more difficult to support additional functionality.

Portable electronic devices typically include at least one man-machine interface (MMI) that allows a user of the electronic device to access the functionalities provided by the portable electronic device. Conventional MMIs may include keypads, touchscreens, computers coupled to the portable electronic device through, for example, a serial connector, a joystick and/or a jogdial. Conventional MMIs, such as a keypad, may occupy a large percentage of the space on the portable electronic device, which may cause the overall size of portable electronic devices to increase. Furthermore, a user may have to use both hands to operate a keypad of other conventional MMI, which may be inconvenient for the user in certain situations. Accordingly, improved MMIs for portable electronic devices may be desired.

### SUMMARY OF THE INVENTION

Embodiments of the present invention provide portable electronic devices including a housing and a display integrated with the housing. A thumb-operable input device is positioned on a side of the housing. An indicator is provided on the display and is operatively associated with the thumb-operable input device. The indicator is positioned on the display to highlight and/or select menu items on the display responsive to input received at the thumb-operable input device.

In some embodiments of the present invention, the thumb-operable input device may further include at least one thumb position sensor. The thumb position sensor may be configured to detect a position of a thumb on the thumb-operable input device and move the indicator on the display between the menu items responsive to the position of the thumb on the thumb-operable input device.

In further embodiments of the present invention, the thumb-operable input device may further include at least one thumb movement sensor configured to detect movement on the thumb-operable input device and a processor operatively associated with the at least one thumb movement sensor. The processor may be configured to process the detected movement and move the indicator on the display between the menu items responsive to the processed movement. The thumb movement sensor may be further configured to detect movement via fingerprint analysis. In these embodiments, the thumb movement sensor may be further configured to detect distortion of a fingerprint on the thumb-operable input device. The processor may be configured to process the detected distortion of the fingerprint and highlight and/or select menu items on the display responsive to the detected distortion.

In still further embodiments of the present invention, the thumb-operable input device may include a slot, a plurality of notches in the slot and a bar configured to move in the slot. Ones of the plurality of notches may be associated with ones of a plurality of menu items. The bar may be configured to move in the slot between the notches to position the indicator on the display to highlight and/or select the associated menu item.

In some embodiments of the present invention, a sensor may be operatively associated with the bar and configured to detect movement of the bar in the slot. A processor may be operatively associated with the sensor. The processor may be configured to process the detected movement of the bar and move the indicator on the display between the menu items responsive to the processed movement.

In further embodiments of the present invention, the thumb-operable input device may include a slot and a bar. The bar may be configured to slide in the slot to position the indicator on the display to highlight and/or select one of a plurality of menu items. The device may further include a sensor operatively associated with the bar and configured to detect movement of the bar in the slot. A processor may be provided that is operatively associated with the sensor. The processor may be configured to process the detected movement of the bar and move the indicator on the display between the menu items responsive to the processed movement. In certain embodiments of the present invention, the thumb-operable input device may further include a spring mechanism. The spring mechanism may be configured to reposition the bar at an end of the slot between selections of menu items.

In still further embodiments of the present invention, the thumb-operable input device may include at least one of a fingerprint sensor, touchpad or hinged bar. The indicator may be configured to move between menu items responsive to upward and/or downward movement on the fingerprint sensor, the touchpad or the hinged bar.

In some embodiments of the present invention, the thumb-operable input device may include a touchpad positioned on a side of the housing. In certain embodiments of the present invention, a sensor may be provided that is operatively associated with the touchpad and configured to detect movement on the touchpad. A processor may be provided that is operatively associated with the sensor. The processor may be configured to process the detected movement on the touchpad and move the indicator on the display between the menu items responsive to the processed movement.

While the present invention is described above primarily with reference to portable electronic devices including MMIs, MMIs and methods of operating portable electronic devices are also provided.

### BRIEF DESCRIPTION OF THE DRAWINGS

FIG. 1 is a schematic diagram of mobile terminals according to some embodiments of the present invention and an exemplary base station transceiver.

FIG. 2 is a schematic diagram illustrating man-machine interfaces (MMIs) according to some embodiments of the present invention.

FIG. 3 is a schematic diagram illustrating keypads and indicators according to some embodiments of the present invention.

FIG. 4 is a schematic diagram illustrating MMIs according to further embodiments of the present invention.

FIG. 5A is a schematic diagram illustrating MMIs according to still further embodiments of the present invention.

FIG. 5B is a schematic diagram illustrating MMIs according to some embodiments of the present invention.

FIG. 6 is a schematic diagram illustrating MMIs according to further embodiments of the present invention.

FIG. 7 is a schematic diagram illustrating MMIs according to still further embodiments of the present invention.

FIG. 8 is a flowchart illustrating operations of portable electronic devices according to embodiments of the present invention.

### DETAILED DESCRIPTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art. It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items.

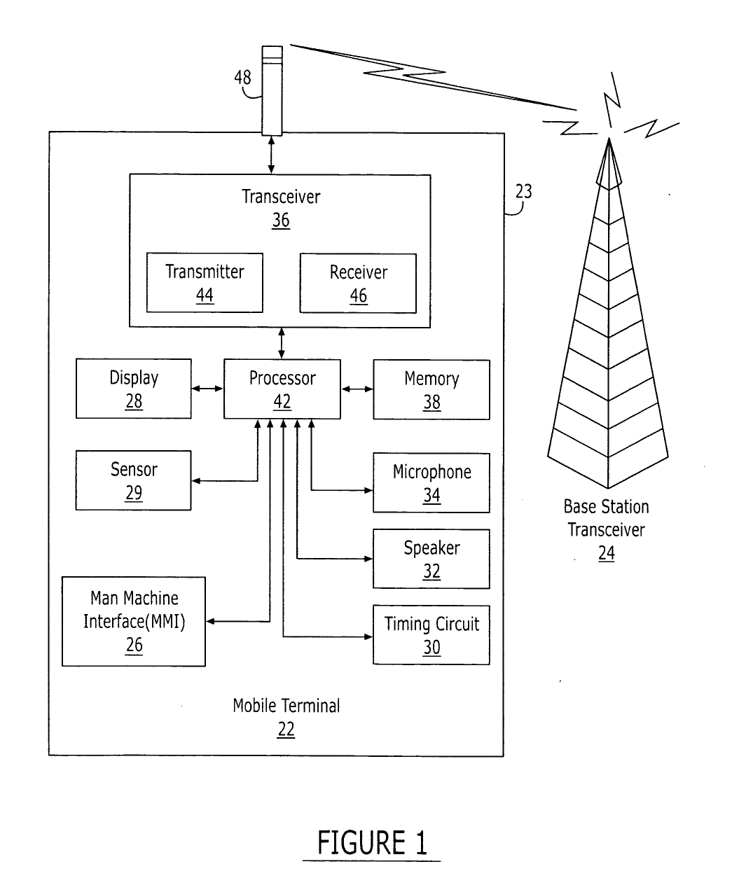

Embodiments of the present invention will now be described below with respect to FIGS. 1 through 8. Embodiments of the present invention provide man-machine interfaces (MMIs) for portable electronic devices, for example, mobile terminals, including a thumb-operable interface device that controls an indicator on a display of the portable electronic device to allow a user to access the functionalities provided by the portable electronic device. An indicator is provided on the display and is operatively associated with the thumb-operable input device. In other words, the indicator is positioned on the display to highlight and/or select menu items on the display responsive to input received at the thumb-operable input device. Accessing the functionalities of the portable electronic device according to embodiments of the present invention may allow a conventional MMI, for example, a keypad, to be omitted from the portable electronic device, which may further allow the overall size of the portable electronic device to be decreased. Furthermore, thumb-operable input devices according to some embodiments of the present invention may enable single-handed operation of the electronic device, which may improve the overall convenience of use of the portable electronic device.

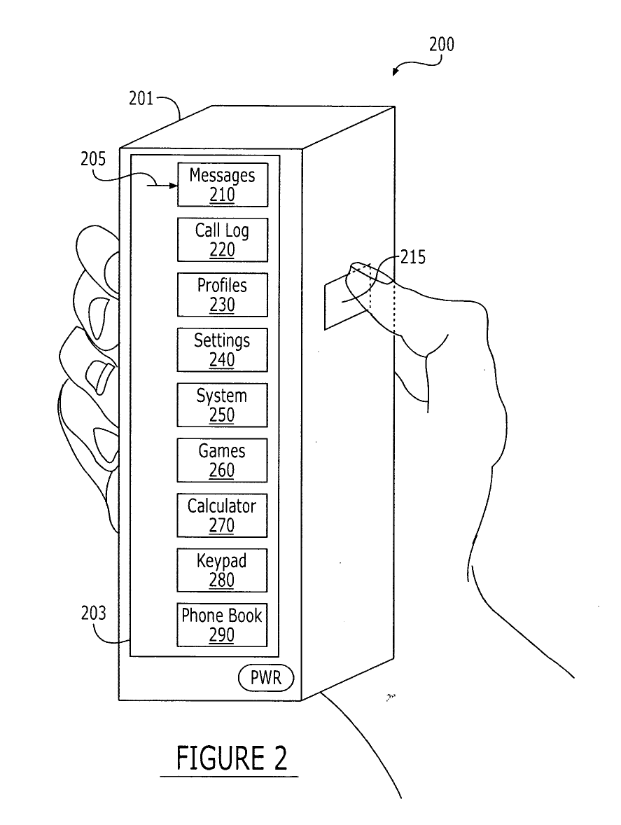

As used herein, “thumb-operable” refers to the intended operation of the device as illustrated, for example, in FIG. 2. However, “thumb-operable” is not intended to exclude the possibility that the device may be operated using some other means. In other words, if a user chooses to operate MMIs according to embodiments of the present invention with his or her index finger, the MMI may still be within the scope of the present invention.

The present invention is described below with reference to schematic and block diagrams of MMIs and devices including the same according to embodiments of the invention. Embodiments of the present invention may be used in conjunction with a mobile terminal, for example, a mobile terminal 22 of FIG. 1. Although MMIs are discussed herein as being included as part of a mobile terminal, embodiments of the present invention are not limited to this configuration.

FIG. 1 illustrates an exemplary radiotelephone communication system, in accordance with embodiments of the present invention, which includes the mobile terminal 22 and a base station transceiver 24 of a wireless communications network. The mobile terminal 22 includes a portable housing 23 and may include a display 28, a speaker 32, a microphone 34, a transceiver 36, and a memory 38, any of which may communicate with a controller/processor 42. Furthermore, mobile terminals 22 according to embodiments of the present invention may further include at least one MMI 26 according to embodiments of the present invention and a sensor 29 associated with the MMI 26, which also communicate with a controller/processor 42. The processor 42 can be any commercially available or custom microprocessor.

The transceiver 36 typically comprises a transmitter circuit 44 and a receiver circuit 46, which respectively transmit outgoing radio frequency signals to the base station transceiver 24 and receive incoming radio frequency signals, such as voice signals, from the base station transceiver 24 via an antenna 48. The radio frequency signals transmitted between the mobile terminal 22 and the base station transceiver 24 may comprise both traffic and control signals (e.g., paging signals/messages for incoming calls), which are used to establish and maintain communication with another party or destination. The controller/processor 42 may support various functions of the mobile terminal 22, including processing signals sensed by the sensor 29 for the MMI 26 with respect to user input and providing signals generated by the sensor 29 to the display 28 so as to allow an indicator on the display to highlight and/or select menu items according to some embodiments of the present invention.

As used herein, the term “personal electronic device” or “mobile terminal” may include: a cellular radiotelephone with or without a multi-line display; a Personal Communications System (PCS) terminal that may combine a cellular radiotelephone with data processing, facsimile and data communications capabilities; a Personal Data Assistant (PDA) that can include a radiotelephone, pager, Internet/intranet access, Web browser, organizer, calendar and/or a global positioning system (GPS) receiver; and a conventional laptop and/or palmtop portable computer that may include a radiotelephone transceiver.

In some embodiments of the present invention, the base station transceiver 24 comprises the radio transceiver(s) that defines an individual cell in a cellular network and communicates with the mobile terminal 22 and other mobile terminals in the cell using a radio-link protocol. Although only a single base station transceiver 24 is shown, it will be understood that many base station transceivers may be connected through, for example, a mobile switching center and other devices to define a wireless communications network.

Although the present invention may be embodied in communication devices or systems, such as the mobile terminal 22, the present invention is not limited to such devices and/or systems. Instead, the present invention may be embodied in any apparatus that may utilize a MMI according to embodiments of the present invention.

Referring now to FIG. 2, a portable electronic device 200, for example, the mobile terminal 22 of FIG. 1, including a MMI 215 according to embodiments of the present invention will be discussed. As illustrated in FIG. 2, the portable electronic device 200 includes a display 203 including one or more menu items. The menu items illustrated in FIG. 2 include messages 210, call log 220, profiles 230, settings 240, system 250, games 260, calculator 270, keypad 280 and phone book 290. It will be understood that the menu items illustrated in FIG. 2 are provided for exemplary purposes only and that embodiments of the present invention are not limited to this configuration. The display 203 further includes an indicator or cursor 205. The MMI of the portable electronic device 200 is provided by a thumb-operable input device 215 provided on a side of the housing 201 of the portable electronic device 200. As illustrated in FIG. 2, MMIs according to embodiments of the present invention may be configured for single-handed operation. Although the thumb-operable input device 215 is provided on a side of the housing 215 in FIG. 2, embodiments of the present invention are not limited to this configuration. The thumb-operable input device 215 may be positioned anywhere on the portable electronic device 200 without departing from the scope of the present invention.

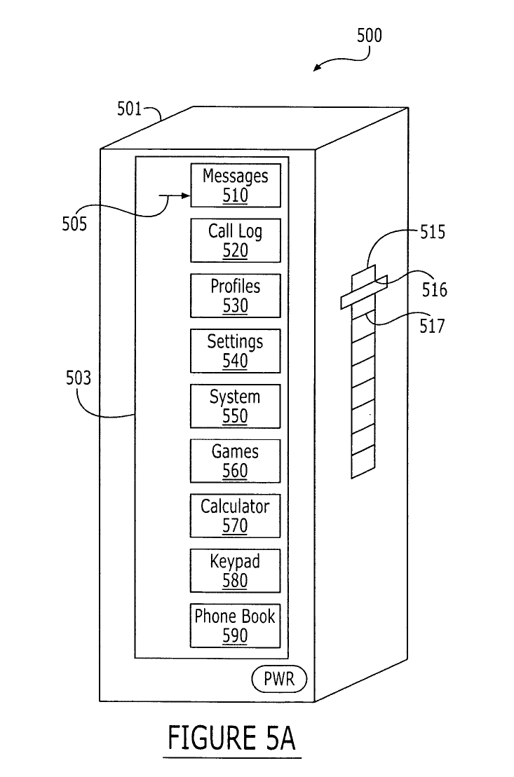

The indicator 205 on the display 203 is operatively associated with the thumb -operable input device 215. The indicator 205 is positioned on the display to highlight and/or select menu items, for example, the messages 210 menu item as illustrated in FIG. 2, on the display 203 responsive to input received at the thumb-operable input device 215. A sensor, for example, sensor 29 of FIG. 1, may be operatively associated with the thumb-operable input device 215 and may be configured to detect movement on the thumb-operable input device 215. A processor, for example, processor 42 of FIG. 1, may also be provided in the portable electronic device 200. The processor may be operatively associated with the sensor and configured to process the detected movement on the thumb-operable input device 215. The indicator 205 may be moved on the display 203 between the menu items responsive to the processed movement. Details with respect to movement of the indicator and highlighting and/or selecting menu items will be discussed further below with respect to FIGS. 4 through 7.

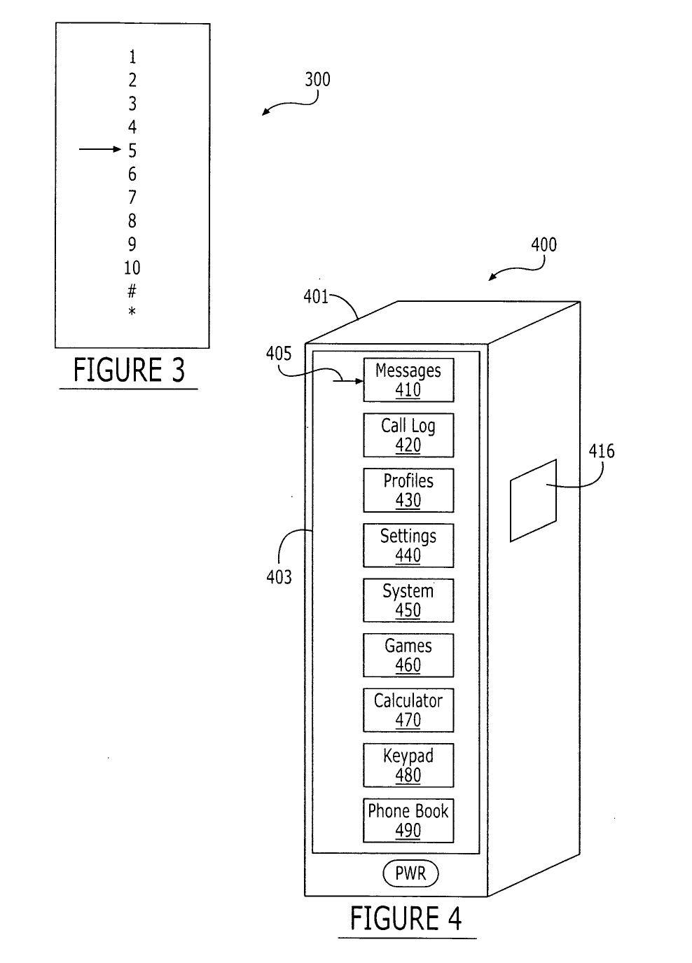

When a menu item, for example, the keypad 280 menu item, is selected a submenu may appear on the display 203. In particular, if the keypad 280 menu item is selected a submenu 300 including items typically included on a conventional keypad may appear on the display 203 as illustrated in FIG. 3. The thumb-operable input device 215 may be used to highlight and/or select items from the submenu 300 to, for example, dial a phone number. It will be understood that the submenu 300 of the keypad 280 illustrated in FIG. 3 is provided for exemplary purposes only and that embodiments of the present invention are not limited to this configuration. It will also be understood that some or all of the remaining menu items may contain similar submenus. For example, submenus for the settings 240 may include volume control, display settings, and the like. The potential contents of the submenus are known to those of skill in the art and will not be discussed further herein.

Referring now to FIG. 4, portable electronic devices 400 including MMIs according to some embodiments of the present invention will be discussed. The details with respect to the housing 401, the display 403, the indicator 405 and the menu items 410 through 490 are discussed above with respect to similar components in FIG. 2 and need not be repeated herein. As illustrated in FIG. 4, the MMI or thumb-operable input device may include at least one thumb movement sensor 416. The thumb movement sensor 416 is configured to detect movement of, for example, a thumb on the sensor 416. In other words, the thumb movement sensor 416 may be configured to sense, for example, a sliding motion of the thumb. The sensor 416 may sense up, down and/or side-to-side motion. The motion of the thumb sensed by the thumb movement sensor 416 may be processed by a microprocessor, for example, processor 42 of FIG. 1, and the indicator 405 may move responsive to the signal processed by the microprocessor.

In some embodiments of the present invention, the thumb movement sensor 416 may use fingerprint analysis to determine motion of the thumb and the direction of the motion. In other words, the sensor 416 may be configured to recognize the pattern of a fingerprint of a thumb or finger operating the thumb-operable input device. For example, if the recognized pattern appears to be moving from a high position to a relatively lower position on the sensor 416, this may cause the indicator to move down the list of menu items or toward the bottom of the display 403 until the movement stops. Similarly, if the recognized pattern appears to be moving from a low position to a relatively higher position on the sensor 416 or a different horizontal position, this may cause the indicator to move up the menu list on the display 403 or from side to side, respectively, until the movement stops.

Furthermore, once the indicator 405 is positioned to highlight the desired menu item, the menu item may be selected using a different pressing sequence or a unique press. For example, the sensor 416 may be configured to sense pressure being placed on the sensor 416 by, for example, a thumb. In embodiments of the present invention using fingerprint analysis, the ridges of the fingerprint may flatten out or distort when more pressure is applied to the sensor 416. Similarly, when the thumb or finger is removed from the sensor 416, the ridges of the fingerprint will disappear. In some embodiments of the present invention, the sensor 416 may be configured to detect distortion of only a portion of the fingerprint, i.e. uniform pressure may not be applied to the sensor 416 by the thumb. For example, if a thumb makes a rolling motion up without actually moving the central position of the thumb on the sensor 416, the fingerprint may only flatten out or become distorted at a top portion of the fingerprint. The processor 42 (FIG. 1) may be configured to detect the distortion in pressure on the top portion of the fingerprint and move the indicator 405 up the menu until uniform pressure is returned to the sensor 416. Accordingly, the sensor 416 may be configured to select a highlighted menu item when relatively more pressure is applied to the sensor 416 either by the whole thumb or portions of the thumb. Furthermore, a second distinct pressing sequence may used to activate the selected menu item. For example, if the seven digits of a phone number have been selected and are displayed on the display 403, two consecutive taps on the sensor 416 may dial the phone number. The details of fingerprint analysis are known to those having skill in the art and need not be discussed in detail herein.

Some embodiments of the present invention may include a timing circuit (designated at 30 of FIG. 1). The timing circuit 30 may be configured to start a timer when a first tap is sensed and to wait for a predetermined period of time for a second tap. If a second tap is sensed by the sensor 416 within the predetermined period of time, the highlighted selection on the display 403 may be selected and, for example, the phone number may be dialed. It will be understood that the pressing sequences discussed above are provided for exemplary purposes only and embodiments of the present invention should not be limited by these example. For example, the timing circuit may be configured to set a timer when a menu item is highlighted and to select the menu item if the timer expires and the menu item is still highlighted without departing from the scope of the present invention.

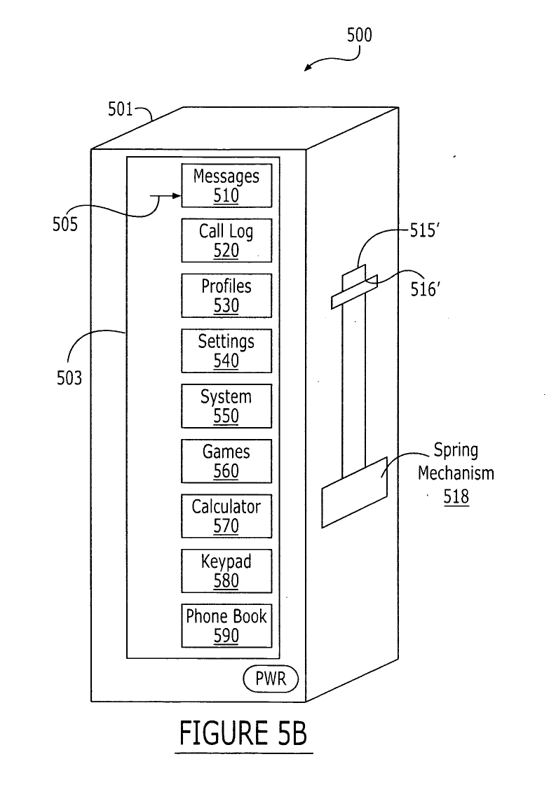

Referring now to FIG. 5A, portable electronic devices 500 including MMIs according to some embodiments of the present invention will be discussed. The details with respect to the housing 501, the display 503, the indicator 505 and menu items 510 through 590 are discussed above with respect similar components in FIG. 2 and need not be repeated herein. As illustrated in FIG. 5A, the MMI or thumb-operable input device may include a slot 515, one or more notches 517 in the slot and a bar 516 configured to slide in the slot. Ones of the notches 517 may be associated a respective one of the menu items. The bar 516 is configured to slide in the slot 515 between the notches 517 to position the indicator 505 on the display to highlight and/or select the menu item associated with the notch. Thus, as discussed above with respect to FIG. 4, the indicator 505 may be positioned to highlight a desired menu item on the display. The desired menu item or items, once highlighted, may be selected by pushing the bar 516 or tapping the bar 516 multiple times as discussed above. In other words, a sensor, for example, sensor 29 of FIG. 1, may be operatively associated with the bar 516 and configured to detect movement of the bar 516 in the slot 517. A processor, for example, processor 42 of FIG. 1, may be operatively associated with the sensor 29. The processor 42 may be configured to process the detected movement of the bar 516 and move the indicator on the display between the menu items responsive to the processed movement.

Some embodiments of the present invention may include the slot 515′ and the bar 516′ without including the notches 517 as illustrated in FIG. 5B. These embodiments may include a spring mechanism 518 configured to reposition the bar 516 at an upper end of the slot 515 between selections of menu items. In other words, the menu item that is highlighted just before the bar 516 returns to the top or bottom of the slot 515 is selected.

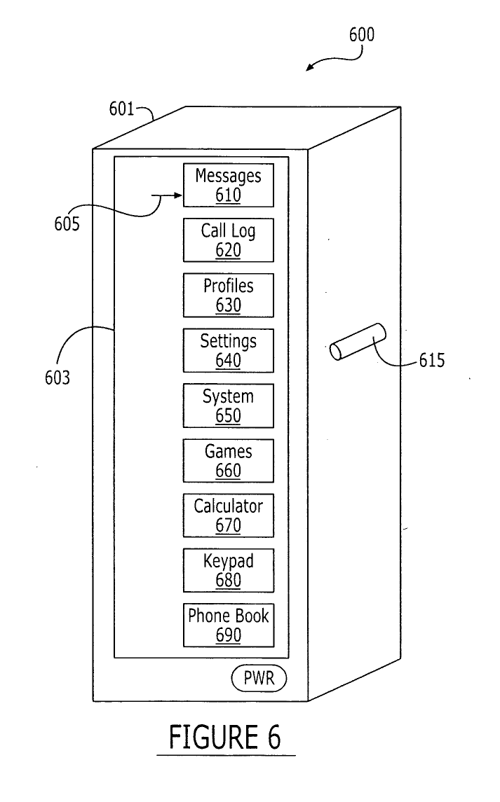

Referring now to FIG. 6, portable electronic devices 600 including MMIs according to some embodiments of the present invention will be discussed. The details with respect to the housing 601, the display 603, the indicator 605 and the menu items 610 through 690 are discussed above with respect to FIG. 2 and will not be repeated herein. The MMI or thumb-operable input device may include, for example, a hinged bar 615. The thumb-operable input device 615 may be configured to be responsive to slight movements of the hinged bar. Although embodiments of the present invention are discussed with respect to a hinged bar, embodiments of the present invention are not limited to this configuration. For example, the thumb-operable input device of FIG. 6 may be, for example, a touchpad or a fingerprint sensor without departing from the scope of the present invention. The indictor 605 may move between menu items responsive to repetitive upward and/or downward motion with respect to the hinged bar 615. For example, if the hinged bar 615 is pressed and held down, the indicator 605 may move down the list of menu items until the pressure on the hinged bar 615 is released. Similarly, if the hinged bar 615 is pressed and held up, the indicator 605 may move up the list of menu items until the pressure of the hinged bar 615 is released.

Embodiments of the thumb-operable input device 615 illustrated in FIG. 6 may include a sensor, for example, sensor 29 of FIG. 1, operatively associated with the hinged bar and configured to detect the slight movements of the hinged bar. A processor, for example, processor 42 of FIG. 1, may be operatively associated with the sensor. The processor 42 may be configured to process the detected movement of the hinged bar 615 and move the indicator 605 on the display between the menu items responsive to the processed movement.

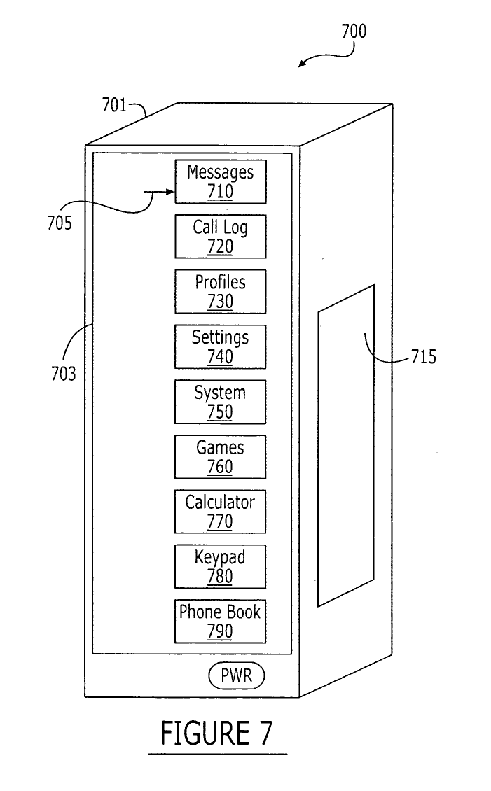

Referring now to FIG. 7, portable electronic devices 700 including MMIs according to some embodiments of the present invention will be discussed. The details with respect to the housing 701, display 703, indicator 705 and menu items 710 through 790 are discussed above with respect to FIG. 2 and will not be repeated herein. As illustrated, the MMI or thumb-operable input device includes a thumb position sensor 715, for example, a touchpad sensor, on a side of the housing 701 of the portable electronic device 700. The place where a thumb or finger touches the thumb position sensor 715 may be translated by the microprocessor, for example, processor 42 of FIG. 1 into a location on the display 703 and the indicator 705 is positioned at this location on the display. In other words, the position of a centroid of the thumb on the thumb position sensor 715 may directly correspond to a position of the indicator 705 on the display 703. In some embodiments of the present invention the thumb position sensor 715 may include a plurality of touchpad sensors, each of which may be configured to correspond to one or more of the menu items without departing from the teachings of the present invention.

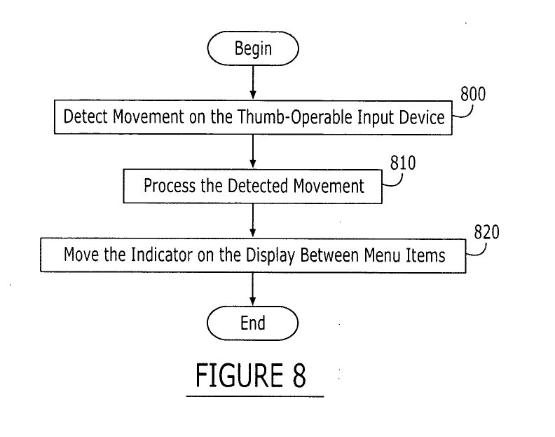

Referring now to FIG. 8, operations of portable electronic devices including MMIs according to still further embodiments of the present invention will be discussed. Operations begin at block 800 by detecting movement on the thumb-operable input device. It will be understood that a thumb-operable input device may be a thumb-operable input device according to embodiments of the present invention discussed above with respect FIGS. 2 through 7. For example, the thumb-operable input device may include, for example, a sensor, a fingerprint sensor, a hinged bar, a touchpad, a sliding bar in a slot and the like without departing from the scope of the present invention.

The movement detected on the thumb-operable input device (block 800) may be processed by, for example, processor 42 of FIG. 1 (block 810). The indicator may be moved between menu items on the display in response to the processed movement (block 820). As discussed above, the indicator may be positioned on the display using the thumb-operable input device to highlight and/or select menu items on the display responsive to input received at a thumb-operable input device. The menu items may include, for example, include menu associate with messages, a call log, profiles, settings, the system, games, a calculator, a keypad, a phone book and the like without departing from the teachings of the present invention.

As briefly discussed above with respect to FIGS. 1 through 8, embodiments of the present invention provide a man-machine interface (MMI) or thumb-operable input device for portable electronic devices. The thumb-operable input device may allow single-handed operation of a portable electronic device as illustrated in FIG. 2, which may eliminate the need for a stylus and/or keypad and simplify the overall operation of the portable electronic device. Furthermore, the presence of, for example, a keypad as a menu item may eliminate the need for an actual keypad on the portable electronic device, which may allow the overall size of the device to be reduced.

In the drawings and specification, there have been disclosed typical illustrative embodiments of the invention and, although specific terms are employed, they are used in a generic and descriptive sense only and not for purposes of limitation, the scope of the invention being set forth in the following claims.

1. A portable electronic device, comprising:
a housing;
a display integrated with the housing;
a thumb-operable input device positioned on a side of the housing;
an indicator on the display operatively associated with the thumb-operable input device, the indicator being positioned on the display to highlight and/or select menu items on the display responsive to input received at the thumb-operable input device.

2. The device of claim 1 wherein the thumb-operable input device comprises at least one thumb position sensor and wherein the thumb position sensor is configured to detect a position of a thumb on the thumb-operable input device and move the indicator on the display between the menu items responsive to the position of the thumb on the thumb-operable input device.

3. The device of claim 1 wherein the thumb-operable input device further comprises:
at least one thumb movement sensor configured to detect movement on the thumb-operable input device; and
a processor operatively associated with the at least one thumb movement sensor, the processor being configured to process the detected movement and move the indicator on the display between the menu items responsive to the processed movement.

4. The device of claim 3, wherein the thumb movement sensor is further configured to detect movement via fingerprint analysis.

5. The device of claim 4, wherein the thumb movement sensor is further configured to detect distortion of a fingerprint on the thumb-operable input device and wherein the processor is further configured to process the detected distortion of the fingerprint and highlight and/or select menu items on the display responsive to the detected distortion.

6. The device of claim 1, wherein the thumb-operable input device comprises:
a slot; and
a bar configured to slide in the slot to position the indicator on the display to highlight and/or select one of a plurality of menu items.

7. The device of claim 6, wherein the thumb-operable input device further comprises:
a plurality of notches in the slot, each of the plurality of notches being associated with one of the plurality of menu items, wherein the bar is further configured to move in the slot between the notches to position the indicator on the display to highlight and/or select the associated menu item.

8. The device of claim 7 further comprising:
a sensor operatively associated with the bar and configured to detect movement of the bar in the slot; and
a processor operatively associated with the sensor, the processor being configured to process the detected movement of the bar and move the indicator on the display between the menu items responsive to the processed movement.

9. The device of claim 6 wherein the thumb-operable input device further comprises a spring mechanism, the spring mechanism being configured to reposition the bar at an end of the slot between selections of menu items.

10. The device of claim 1 wherein the thumb-operable input device comprises at least one of a fingerprint sensor, touchpad or hinged bar, wherein the indicator is configured to move between menu items responsive to upward and/or downward movement on the fingerprint sensor, the touchpad or the hinged bar.

11. The device of claim 1, wherein the thumb-operable input device comprises a touchpad positioned on a side of the housing.

12. The device of claim 11 further comprising:
a sensor operatively associated with the touchpad and configured to detect movement on the touchpad; and
a processor operatively associated with the sensor, the processor being configured to process the detected movement on the touchpad and move the indicator on the display between the menu items responsive to the processed movement.

13. A man-machine interface (MMI) for a portable electronic device, comprising:
a thumb-operable input device; and
an indicator on a display of the portable electronic device, the indicator being operatively associated with the thumb-operable input device and positioned on the display to highlight and/or select menu items on the display responsive to input received at the thumb-operable input device.

14. The MMI of claim 13 wherein the thumb-operable input device comprises at least one thumb position sensor and wherein the thumb position sensor is configured to detect a position of a thumb on the thumb-operable input device and move the indicator on the display between the menu items responsive to the position of the thumb on the thumb-operable input device.

15. The MMI of claim 13 wherein the thumb-operable input device further comprises:
at least one thumb movement sensor configured to detect movement on the thumb-operable input device; and
a processor operatively associated with the at least one thumb movement sensor, the processor being configured to process the detected movement and move the indicator on the display between the menu items responsive to the processed movement.

16. The MMI of claim 15, wherein the thumb movement sensor is further configured to detect movement via fingerprint analysis.

17. The MMI of claim 16, wherein the thumb movement sensor is further configured to detect distortion of a fingerprint on the thumb-operable input device and wherein the processor is further configured to process the detected distortion of the fingerprint and highlight and/or select menu items on the display responsive to the detected distortion.

18. The MMI of claim 14 wherein the thumb-operable input device comprises:
a slot; and
a bar configured to slide in the slot to position the indicator on the display to highlight and/or select one of a plurality of menu items.

19. The MMI of claim 18 wherein the thumb-operable input device further comprises:
a plurality of notches in the slot, each of the plurality of notches being associated with one of the plurality of menu items, wherein the bar is configured to move in the slot between the notches to position the indicator on the display highlight and/or select the associated menu item.

20. The MMI of claim 19 wherein the bar is operatively associated with a sensor that is configured to detect movement of the bar in the slot and wherein the sensor is operatively associated with a processor that is configured to process the detected movement of the bar and move the indicator on the display between the menu items responsive to the processed movement.

21. The MMI of claim 18 wherein the thumb-operable input device further comprises a spring mechanism, the spring mechanism being con figured to reposition the bar at an end of the slot between selections of menu items.

22. The MMI of claim 14 wherein the thumb-operable input device comprises at least one of a fingerprint sensor, touchpad or hinged bar, wherein the indicator is configured to move between menu items responsive to upward and/or downward movement on the fingerprint sensor, the touchpad or the hinged bar.

23. The MMI of claim 14 wherein the thumb-operable input device comprises a touchpad.

24. The MMI of claim 23 wherein the touchpad is operatively associated with a sensor that is configured to detect movement on the touchpad and wherein the sensor is operatively associated with a processor that is configured to process the detected movement on the touchpad and move the indicator on the display between the menu items responsive to the processed movement.

25. A method of operating a portable electronic device comprising positioning an indicator on a display to highlight and/or select menu items on the display responsive to input received at a thumb-operable input device.

26. The method of claim 25, further comprising:
detecting movement on the thumb-operable input device;
processing the detected movement; and
moving the indicator on the display between the menu items responsive to the processed movement.

27. The method of claim 26 wherein detecting movement on the thumb-operable input device comprises detecting movement via fingerprint analysis.

28. The method of claim 27, wherein detecting movement further comprises:
detecting distortion of a fingerprint on the thumb-operable input device; and
processing the detected distortion of the fingerprint; and
highlighting and/or selecting menu items on the display responsive to the processed distortion.

29. The method of claim 25 wherein positioning the indicator comprises sliding a bar in a slot in a housing of the portable electronic device to position the indicator on the display to highlight and/or select one of a plurality of menu items.

30. The method of claim 29 wherein positioning the indicator further comprises:
moving the bar in the slot between a plurality of notches associated with one of the plurality of menu items to position the indicator on the display to highlight and/or select the associated menu item.

31. The method of claim 29 further comprising repositioning the bar at an end of the slot between selections of menu items.

32. The method of claim 25 wherein positioning the indicator further comprises moving the indicator between the menu items responsive to upward and/or downward movement on a fingerprint sensor, a touchpad or a hinged bar.
